(19) United States
(12) Patent Application Publication
(10) Pub. No.: US 2026/0145103 A1
(43) Pub. Date: May 28, 2026

(54) FILTERING DEVICE ASSEMBLY WITH PASSIVE BYPASS-SWITCH UNIT

(71) Applicant: Planetcare D.O.O., Ljubljana (SI)

(72) Inventors: Lenche GJORGJIOSKI, Ljubljana (SI); Miha FLISEK, Zagorje ob Savi (SI); Miha VRHOVEC, Horjul (SI)

(21) Appl. No.: 19/114,727

(22) PCT Filed: Sep. 21, 2023
(86) PCT No.: PCT/EP2023/076070

§ 371 Date: Mar. 24, 2025

(30) Foreign Application Priority Data
Sep. 29, 2022 (DE) 10 2022 125 214.0

(51) Int. Cl. B01D 35/147; B01D 35/143

(52) U.S. Cl. CPC B01D 35/147; B01D 35/143; B01D 2201/34; B01D 2201/4069; B01D 2201/52

(57) ABSTRACT

The present disclosure concerns a filtering device assembly comprising an inlet, an outlet, and a bypass-switch unit fluidly connectable to a filter screen unit for filtering particles, in particular plastic particles, from a flow of liquid flowing from the inlet to the outlet, the bypass-switch unit comprising a switch valve moveable between a filtering position and a bypass position, wherein in the filtering position the bypass-switch unit directs the flow of liquid through a filter screen unit, and in the bypass position the bypass-switch unit bypasses the flow of liquid past the filter screen unit, characterized in that the bypass-switch unit is a passive bypass-switch unit, which is manually switchable between the filtering position and the bypass position and is switchable by pressure from the liquid flow. The disclosure further concerns a corresponding method of operating a filtering device assembly.

### BACKGROUND

### Technical Field

The present disclosure concerns a filtering device assembly according to the independent device claim and a corresponding method of operating a filtering device assembly according to the independent method claim.

### Description of the Related Art

There is an increasing need for making the use of filtering devices that filter harmful particles, in particular plastic particles, such as plastic fibers, from particle-contaminated liquids, such as textile washing wastewater, more attractive for users in order to reduce the negative impact of such harmful particles on the environment.

The cleaning actions of such filtering devices are rather cumbersome, often inconvenient, complex, and unhygienic, which, in particular with regard to a use with domestic appliances, leave room for improvement regarding the ease of use for the end user. Furthermore, as users sometimes dread the required cleaning action or disregard recommended cleaning intervals, there is a risk that such filtering devices clog to such an extent that malfunctions or damage to the device itself or connected devices occur. For example, a connected upstream textile washing machine could interrupt its washing procedure when an increase of liquid pressure in the washing machine drain pipe is detected.

GB2582042 A discloses a microplastic effluent separator provided with a sensor for detecting fluid pressure at the inlet. The sensor is arranged to communicate with a warning system, such that, when in use, if the fluid pressure measured by the sensor rises above a first threshold, a warning signal is issued that the separator needs maintenance. The separator further includes a bypass duct between the inlet and the outlet, wherein the bypass duct is engaged by operation of a bypass valve. The sensor is arranged to operate the bypass valve if, when in use, the fluid pressure measured by the sensor rises above a second threshold, indicating that there is a blockage in the chamber of the separator. While such systems in principle work, they are complex and depend on electric power for detecting the fluid pressure and for activating the bypass in an overpressure situation. The complexity of such systems involves a certain risk for operating errors by the user during maintenance or of failures in general as well as when electricity is temporarily unavailable or the user forgets to reconnect the device to electricity after maintenance.

### BRIEF SUMMARY

The present disclosure has the objective to enable a simple-to-handle and still reliable filtering device that reduces the various risks of malfunctions due to clogging of the filter.

The present disclosure suggests achieving the object by a filtering device assembly according to the independent device claim.

The disclosure suggests a filtering device assembly comprising an inlet, an outlet, and a bypass switch unit fluidly connectable to a filter screen unit for filtering particles, in particular plastic particles, from a flow of liquid flowing from the inlet to the outlet, the bypass-switch unit comprising a switch valve moveable between a filtering position and a bypass position, wherein in the filtering position the bypass-switch unit directs the flow of liquid through a filter screen unit, and in the bypass position the bypass-switch unit bypasses the flow of liquid past the filter screen unit, wherein the bypass-switch unit is a passive bypass-switch unit manually switchable between the filtering position and the bypass position and switchable by pressure from the liquid flow.

By providing a filtering device assembly with a passive bypass-switch unit which is manually switchable between the filtering position and the bypass position and is also switchable by pressure from the liquid flow, the bypass-switch unit enables a filtering device having a multitude of clogging-damage-reducing features as the switch valve can be moved and switched by various non-electric means, e.g., manually or liquid pressure-induced, and its movement can, e.g., be used for a visual indication of operational states of the filtering device, all without electric power.

With the bypass-switch unit being manually switchable, the user has the convenient possibility to activate the bypass mode when no filtering of liquid is desired. This can, e.g., be the case when there are no harmful particles present in the liquid which would otherwise quickly clog the filter screen unit, e.g., mud, sand or biodegradable particles and fibers, such as wool. By such an action, the service life of the filtering device can be strongly increased and the risk of clogging-related malfunctions reduced. Further, the user can also manually activate the filtering mode when the filtering device assembly is in the bypass mode.

Further, by making the bypass-switch unit switchable by pressure from the liquid flow, a simple and reliable automatic overpressure safety system is realized.

The aforementioned term “passive” means that the bypass-switch unit is configured to be operated without the use of external energy sources, including electrical power (electric cable or battery), relying instead on forces by a user manually operating the device or on the pressure forces of the liquid being filtrated.

In a possible embodiment, the bypass-switch unit comprises a hand-switch movably associated with the switch valve.

This allows for an easy and toolless switching of the switch unit by hand, for example at an easily accessible location on the outer side of the filtering device assembly.

In another possible embodiment, a part of the switch valve is exposed to a differential liquid pressure between the inlet-side and the outlet-side of a filter screen unit and is movable by a differential liquid pressure from the filtering position in the direction of the bypass position.

In this embodiment in which a part of the switch valve is exposed to a differential liquid pressure between the inlet-side and the outlet-side of a filter screen unit, the activation of the bypass mode can be made dependent on the actual differential pressure, i.e., the pressure loss within the filtering device.

In an optional further embodiment, a visual indicator is configured to visually indicate an operational state of the switch valve, in particular the visual indicator is configured to visually indicate when the switch valve is in the bypass position and/or the filtering position, more particularly when the filtering device assembly is, according to an embodiment described heretofore, the hand switch comprises the visual indicator.

The visual indicator gives the user a convenient visual feedback about an operational state of the switching valve and thus delivers operational information to the user without the need for electric power.

With the visual indicator optionally visually indicating to a user when the switch valve is in the bypass position, the user gets a visual feedback when the device is in a bypass condition and thus a clear signal of when the filter screen unit is clogged and needs cleaning or a replacement by the user.

With the visual indicator further optionally indicating to a user that the switch valve is in the filtering position, the user gets a visual feedback of when the device is in its normal use state.

In a further optional embodiment, the visual indicator is configured to visually indicate when the switch valve is in the bypass position and to indicate when the switching valve is in the filtering position.

In a further optional embodiment, the hand-switch comprises the visual indicator according to one of the aforementioned embodiments, and the hand-switch and the visual indicator can be embodied by the same part of the filtering device assembly, which allows for a compact design with the single part having a larger size.

In a further, optional embodiment, the switch valve requires manual operation to be moved from the bypass position into the filtering position.

Such a configuration ensures that the switch valve is not moved back to the filtering position by other actions than an intended action by a user, such as for example by any pressure conditions within the filtering device assembly and/or gravity.

In an advantageous, possible embodiment, the bypass-switch unit is a bistable switch unit with the first stable state being the switch valve in the filtering position and the second stable state being the switch valve in the bypass position, in particular wherein the switch valve is held in the first and/or the second stable state by magnetic forces.

Configuring the bypass-switch unit as a bistable switch unit is a reliable and simple solution to ensure that the switch unit is either in the filtering state or in the bypass state and not in any in-between states, such as half-filtering and half-bypassing which can often be undesired. In such in-between states of the bypass-switch unit, the water flow cross-section is reduced and the surrounding surfaces are prone to deposits of fibers and other solid residues. Further, a bistable switch unit reduces unwanted switching to the bypass mode when dynamic pressure changes, e.g., pressure spikes during water inrush, occur during operation. A bistable switch unit also helps to avoid undesired oscillation between bypass and filtering mode.

Optionally, the switch valve is held in the first and/or the second stable state by magnetic forces. It has turned out that the use of magnetic forces resulted in a particularly good performance of the bistable state, as the magnetic forces holding the switch valve in one or two of the stable states can be clearly defined and are repeatable and reliable.

In a further, possible embodiment, the filtering device assembly comprises a switching force setting unit movably associated with the switch valve for defining and/or adjusting threshold switching forces to be overcome for moving the switch valve from the filtering position in the direction of the bypass position and/or from the bypass position in the direction of the filtering position.

With the switching force setting unit, it is possible to define and/or to adjust the threshold switching forces and thus the desired liquid switching pressure. This is beneficial as for example different effluent producing machines will have different capacities / tolerances for pressure drops in the drain line due to different drain pump specifications and due to different programming of the machine controller.

Further, this allows to make use of the maximum capacity of the filter screen unit to prevent machine errors and to decrease user intervention necessity.

In an embodiment, the switching force setting unit defines the threshold switching forces. In a further embodiment, the switching force setting unit adjusts the threshold switching forces. In another embodiment, the switching force setting unit defines and adjusts the threshold switching forces.

Furthermore, with the switching force setting unit being movably associated with the switch valve, it is possible to locate this unit at different locations of the device other than the switch valve itself, while it is still linked to the switch valve motion. This allows for a specifically designed environment for the switching force setting unit which increases the reliability of the defined and/or adjusted threshold forces.

All the aforementioned threshold switching forces can be defined and/or adjusted for moving the switch valve from the filtering position in the direction of the bypass position; for moving the switching valve from the bypass position in the direction of the filtering position; or for both movements.

In yet another beneficial embodiment, the switching force setting unit comprises interacting magnetic members moveable relative to each other for defining the threshold switching forces by magnetic forces, in particular wherein a moveable magnetic member is movably associated with the switch valve and configured to move along a path between a bypass stop position and a filtering stop position, wherein each stop position is in magnetic proximity to a stationary magnetic member.

The use of magnetic members, such as permanent magnets or ferromagnetic parts, that interact by magnetic attraction forces with each other, showed reliable and repeatable results for defining threshold switching forces.

The optional and beneficial arrangement of the moveable magnetic member that is movably associated with the switch valve and in magnetic proximity to a stationary magnetic member in each stop position turned out to be a particularly reliable and non-electric arrangement showing the desired performances.

In another, optional embodiment, the moveable magnetic member is configured to allow for a change of its magnetic strength, in particular the moveable magnetic member comprises a magnetic carrier containing several receiving portions for attaching and/or detaching magnetic subunits.

The possibility to change the magnetic strength of the moveable magnetic member allows to precisely define the desired threshold switching forces in a convenient manner, e.g., during the assembly process of the filtering device assembly, while the threshold forces can be adapted to the particular application case.

In the optional embodiments in which the moveable magnetic member comprises a magnetic carrier containing several receiving portions for attaching magnetic subunits, or for attaching and detaching magnetic subunits, or for detaching magnetic subunits, it is beneficial that the magnetic carrier structure itself fits to several different switching force application cases, while the forces themselves can be easily defined by attaching and/or detaching the appropriate amount of magnetic subunits, such as, for example, permanent magnets, which then interact with stationary ferromagnetic units, or such as, for example, ferromagnetic units, which then interact with stationary permanent magnets.

In another, beneficial, possible embodiment, the switching force setting unit comprises a switching force adjustment mechanism configured to adjust a distance between the moveable magnetic member and at least one of the stationary magnetic members, in particular the switching force adjustment mechanism comprises a thread-system, more particularly a thread-system for adjusting the position of the moveable magnetic member.

Such a switching force adjustment mechanism allows for adjusting the magnetic forces, and thus the threshold switching forces, between the moveable and the stationary magnetic members, for example in the stop positions. It is therefore possible to adjust the switching forces without the need to change or modify the magnetic members themselves.

In an optional embodiment, the switching force adjustment mechanism comprises a thread-system, which is a system able to reliably keep the adjusted distances under force and advantageous for axial fine adjustments.

In a further, optional embodiment, the switching force adjustment mechanism comprises a thread system for adjusting the position of the moveable magnetic member. Adjusting the position of the moveable magnetic member in comparison to adjusting the position of one or more stationary magnetic members allows to affect the magnetic forces between the moveable and the stationary parts at different positions of the moveable part. Adjusting the position and thus the magnetic forces of the moveable magnetic member in the proximity of one stationary magnetic member will also affect the position and thus the magnetic forces of the moveable part when it is in the proximity of the other stationary magnetic member.

In a further, possible embodiment, the switching force adjustment mechanism is manually operable, in particular, the thread system is operable by manually turning an adjustment wheel of the adjustment mechanism and/or the adjustment mechanism is manually operable when the filtering device assembly is filled with liquid.

The possibility to operate the switching force adjustment mechanism by hand allows for a convenient and, for example, toolless adjustment of switching forces by the user.

In a further embodiment, the thread system is operable by manually turning an adjustment wheel of the adjustment mechanism. Operating the thread system by turning an adjustment wheel is a way to allow for an easy and precise adjustment of the switching forces.

In another, advantageous embodiment, the switching force adjustment mechanism is manually operable when the filtering device assembly is filled with liquid. This allows to conveniently adjust the switching forces without the need for disconnecting the filtering device from the pipes or the need for any disassembly. Further, it is possible to operate the adjustment mechanism during the actual filtering process, which, for example, allows to adjust, test and find the desired switching forces while taking into account the forces that usually occur during the filtering process.

In a particular, advantageous embodiment, the bypass-switch unit comprises a switch valve housing containing the switch valve, wherein the switch valve housing and the switch valve are adapted to each other such that the switch valve is blocking the bypass flow over a certain length of travel of the switch valve from the filtering position to the bypass position, in particular over at least a third of the length of travel from the filtering position to the bypass position, more particularly over at least half of the length of travel from the filtering position to the bypass position.

By the switch valve blocking the bypass flow over a certain length of travel of the switch valve from the filtering position to the bypass position it is possible to ensure that the switch valve travels for a desired length before a bypass flow starts. This length of travel can for example be used to ensure that the bypass-switch unit shows a reliable bistable behavior during operation and helps to avoid undesired oscillating movements of the switch valve. Further, such an arrangement can be used to work as a sort of buffer or damping element to reduce the occurrence of undesired switching to the bypass position due to temporary liquid pressure peaks The aforementioned benefits apply in particular when, in optional embodiments, the switch valve blocks the bypass flow over at least a third of the length of travel from the filtering position to the bypass position, and even more when the switch valve is blocking the bypass flow over at least half of the length of travel from the filtering position to the bypass position.

In another, possible embodiment, the moveable switch valve is guided by a bearing, wherein the bearing is sealed off from the liquid flow by a shape-changeable sealing changing its shape along with the switch valve movement, in particular by a flexible sealing sleeve, for example by a bel-lows-like membrane sealing sleeve.

A shape-changeable sealing changing its shape along with the switch valve movement ensures a reliable sealing of the bearing despite movement of the switch valve, and thus ensure that no ingress of liquid and liquid contaminants could increase the friction in the bearing and thus could negatively affect and change the switching process or forces. This eliminates or at least strongly reduces the risk that the performance of the bypass switch unit could be corrupted by the liquid to be filtered and thus reduces the risk of malfunctions.

In a further embodiment, the shape-changeable sealing is a flexible sealing sleeve which allows for an efficient sealing of the bearing.

In another, beneficial embodiment the shape-changeable sealing is a bellows-like membrane sealing sleeve, which further reduces any undesired effects on the switching forces and ensures high reliability.

Further possible embodiments relate to a filtering device comprising a filtering device assembly according to one or more embodiments as described above, and a filter screen unit fluidly connected to the bypass-switch unit for filtering particles, in particular plastic particles, from a flow of liquid flowing from the inlet to the outlet.

The present disclosure further suggests achieving the initially-stated object by a method of operating a filtering device assembly for filtering particles, in particular plastic particles, from liquid flowing through the filtering device assembly, wherein the method comprises the step of manually switching a moveable switch valve of a passive bypass-switch unit between a filtering position and a bypass position, wherein in the filtering position the bypass-switch unit directs the flow of liquid through a filter screen unit, and in the bypass position the bypass-switch unit bypasses the flow of liquid past the filter screen unit, and the method further comprises the step of switching the switch valve by pressure from the liquid flow.

The clogging-damage-reducing effects and benefits enabled by such a method have already being explained initially herein in connection with the independent device claim.

In optional embodiments, the method is characterized by operating a filtering device assembly according to one or more embodiments as described above or by operating a filtering device as described above.

In further possible embodiments of some or all of the aforementioned embodiments, the filtering device assembly or filtering device is operating while being under internal liquid pressure in the filtering mode and/or in the bypass mode. In further embodiments, the aforementioned filtering device assembly as well as its corresponding filtering device are configured to be operable under internal liquid pressure in the range from 0.03 bar to 0.3 bar, in particular in the range from 0.04 bar to 0.25 bar.

In further possible and preferred embodiments, the filtering device assembly or the filtering device according to the aforementioned embodiments is for filtering the wastewater of textile washing machines, in particular of domestic textile washing machines. It has been realized that the disclosure can in particular improve the performance and service life of filtering devices filtering textile wash wastewaters.

In further possible embodiments, the filtering device assembly and the filtering device according to the aforementioned embodiments is configured as an external and portable device that can be retrofitted to wastewater-producing machines, such as textile washing machines.

In further possible embodiments, the filtering device assembly or filtering device according to the aforementioned embodiments can be attached to the outer casing of a textile washing machine or in its vicinity.

In further possible embodiments of the aforementioned embodiments, the mentioned threshold switching forces of the switch valve for switching from the filtering position in the direction of the bypass position and/or for switching from the bypass position in the direction of the filtering position are in the range from 2 Newton to 25 Newton, in particular in the range from 3 Newton to 20 Newton.

### BRIEF DESCRIPTION OF THE SEVERAL VIEWS OF THE DRAWINGS

In order to improve the understanding of the disclosure, possible embodiments of the disclosure constituting advantageous combinations of various aforementioned embodiments will now be described with reference to the following figures:

FIG. 1 shows a perspective view of a filtering device having a filtering device assembly according to an embodiment of the disclosure. The filtering device assembly is in a filtering mode,

FIG. 2 shows the filtering device of FIG. 1 in a bypass mode,

FIG. 3 shows the device of FIG. 1 cut along a plane indicated by line I-I in FIG. 1,

FIG. 4 shows the upper section of FIG. 3 in a perspective orthogonal to the sectional plane of FIG. 3,

FIG. 5 shows a similar section as FIG. 4, with the filtering device in the bypass mode,

FIG. 6 shows a moveable magnetic member in accordance with an embodiment of the disclosure.

### DETAILED DESCRIPTION

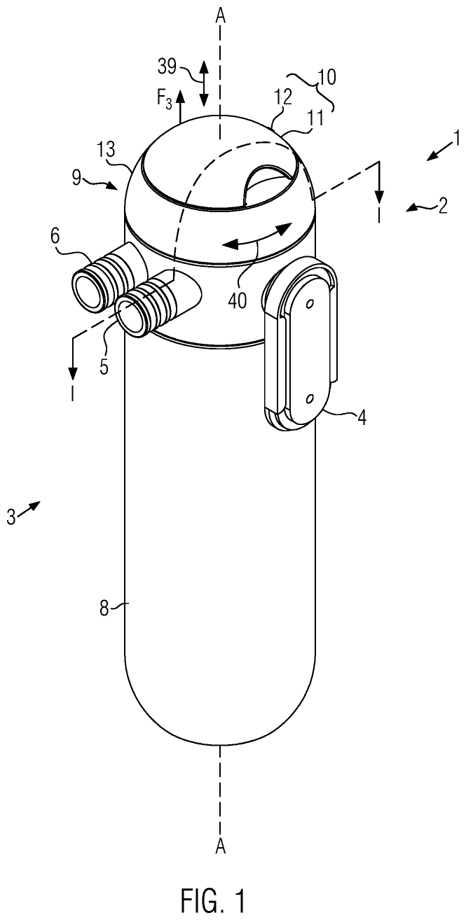

FIG. 1 shows a filtering device 1 comprising a filtering device assembly 2 according to an embodiment of the disclosure, a filtering device housing 3 and a mounting bracket 4.

The filtering device assembly 2 inter alia comprises an inlet 5, an outlet 6 and a passively switchable, in particular non-electrically switchable, bypass-switch unit 7.

The filtering device housing 3 comprises a main body 8 detachable and re-attachable to a head body 9 of the filtering device housing 3. The head body 9 is provided with the inlet 5, the outlet 6 and the mounting bracket 4.

The filtering device housing 3 in this embodiment has basically a cylindrical, rotationally-symmetric shape extending along a main axis A, the head body 9 has a rounded upper-end portion and the main body 8 has a bottle-base-like lower-end portion.

The inlet 5 is connectable to a source emitting a pressurized liquid flow to be filtered. Here in this embodiment, the inlet 5 is connectable to a drain pipe of a domestic textile washing machine (not illustrated) to receive actively pumped waste water, under pressure, from the washing machine.

The outlet 6 is connectable to a drain pipe leading away from the filtering device, in particular leading to a sewer system (not illustrated).

Here in this embodiment, the inlet 5 and the outlet 6 are both arranged parallel and adjacent to each other, at the same side of the filtering device assembly 2 and both in orthogonal orientation to axis A.

The dome-shaped upper part of the head body 9 is a multipurpose head part 10 of the filtering device assembly 2, which, in this embodiment, embodies a hand-switch 11 of the bypass switch unit 7 together with a visual indicator 12 indicating an operational state of the filtering device assembly 2 in a single part. The multipurpose head part 10 is shown in FIG. 1 in a retracted position and is movable along axis A by forces F2, F3, indicated by arrows, from the outside of the filtering device assembly 2, for example applied by the hand of a user, to an extended position and back. The motion arrows 39 in the figures illustrate said movement. The lower part of the head body 9 comprises an adjustment wheel 13 of a switching force adjustment mechanism 14. The adjustment wheel 13 is here in the form of a rotatable outer section of the filtering device assembly 2 and can be turned clockwise and counter clockwise around axis A, as indicated by the motion arrows 40 in the figures. This will be explained further below.

In this embodiment and possible further embodiments, the filtering device 1 is a portable and external device, which can, for example, be attached to the outer wall of a domestic washing machine (not illustrated) by the mounting bracket 4.

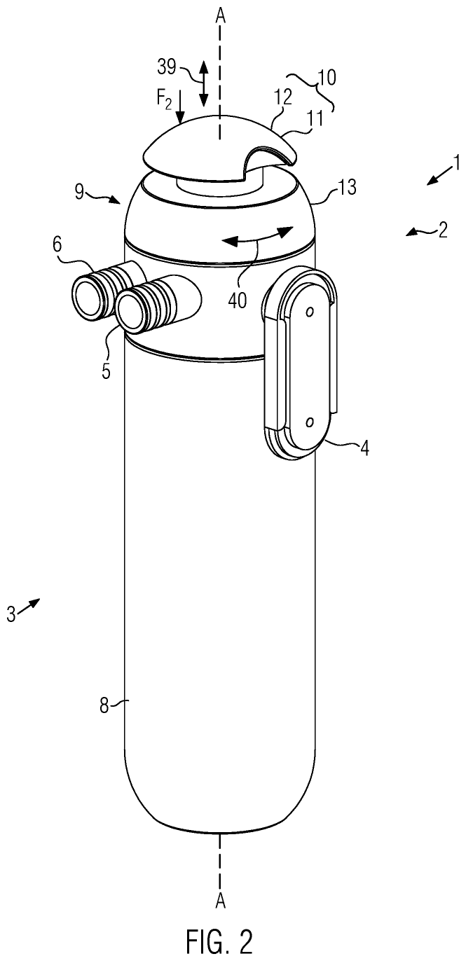

FIG. 2 shows the filtering device 1 in a bypass mode in which the multipurpose head part 10, here inter alia embodying the visual indicator 12, has been moved to its extended position visually indicating to a user that the filtering device assembly 2 is in the bypass mode.

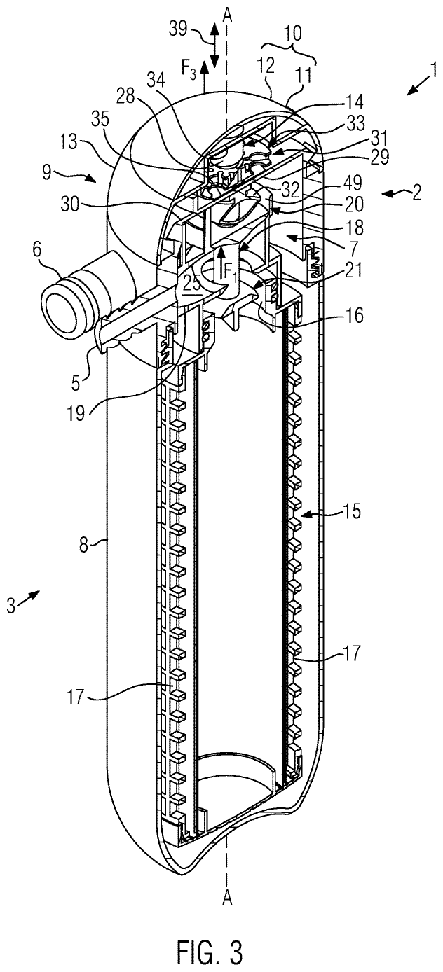

FIG. 3 shows the filtering device 1 cut along a plane indicated by line I-I in FIG. 1 and parallel to axis A.

The interior of the main body 8 comprises a filter screen unit 15 for filtering polluting particles, in particular plastic particles, such as plastic fibers from clothing, from a liquid flow entering the filtering device 1 through the inlet 5 at the inlet side of the filter screen unit 15, flowing through the filtering walls of the filter screen unit 15 and exiting the filtering device 1 through the outlet 6. The filtered particles remain captured within the filter screen unit 15. The filter screen unit 15 can be removed together with the filtered particles and, for example, can be cleaned or replaced by a fresh one, and then inserted into the filtering device 1. The filter screen unit 15 extends along axis A and has a hollow, cylindrical shape with a single inlet opening 16 and filtrating sidewalls 17.

The filter screen unit 15 is in fluid connection to and removably attached to the lower side of the bypass-switch unit 7. The bypass-switch unit 7 is located within the head body 9 at the level of the inlet 5 and outlet 6. The bypass-switch 7 unit is in fluid connection with the inlet.

The herein mentioned filter screen unit can be made of or comprise any type or form of filter media for filtering any type or form of particles mentioned herein and is, in its broadest sense, not to be understood to be limited to filter screens in the sense of solid sieves.

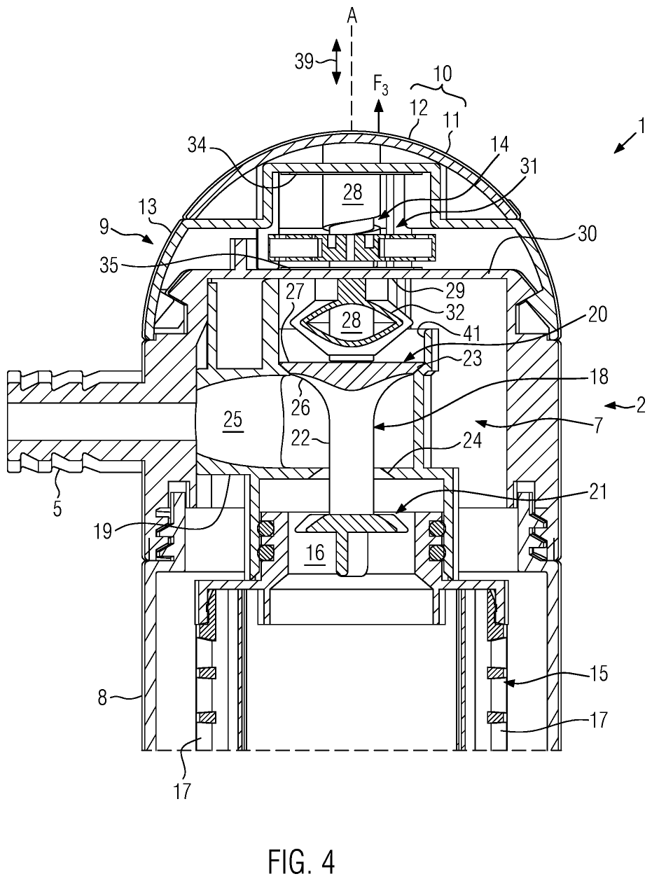

As can be seen in FIG. 4 showing an enlarged upper section of FIG. 3, the non-electrically switchable bypass-switch unit comprises a moveable switch valve 18 and a switch valve housing 19. The switch valve 18 extends along axis A through the switch valve housing 19 and, in this embodiment, the switch valve 18 comprises two valve disks 20, 21 on opposite ends of a valve rod 22. Each valve disk 20, 21 has a corresponding valve seat opening 23, 24 in the switch valve housing 19 for closing the respective valve seat opening 23, 24 when the respective valve disk 20, 21 has been fully moved into its corresponding valve seat opening 23, 24. The switch valve housing 19 has the two valve seat openings 23, 24 as well as an inlet opening 25 in fluid connection with the inlet 5.

One of the valve seat openings, the upper one 23 in FIG. 4, forms a bypass opening allowing the liquid flow from the inlet 5 to flow past, i.e., to bypass, the filter screen unit 15 and to flow directly to the outlet 16 and to exit the filtering device 1 unfiltered.

The other of the valve seat openings, the lower one 24 in FIG. 4, forms a filter opening allowing the liquid flow from the inlet 5 to enter the filter screen unit 15 which is there attached to the switch valve housing 19. The liquid flow is then filtered by the walls 17 of the filter screen unit 15 and then leaves the filtering device 1 through the outlet 6.

As can best be seen in FIG. 4, when the bypass valve disk 20 is in its closed position, the lower side 26 of the valve disk 20 is exposed to the interior of the switch valve housing 19 and thus is exposed to the liquid pressure on the inlet-side of the filter screen unit 15. The upper side 27 of the bypass valve disk 20 is exposed to the downstream side of the filter screen unit 15 and thus to the liquid pressure on the outlet-side of the filter screen unit 15. When the bypass valve disk 20 is in the closed position and sitting in the bypass valve seat opening 23, the filter valve disk 21 is in the open position distanced to the filter valve seat opening 24, and vice versa.

The switch valve housing 19 comprises a tunnel 41 or barrel-shaped section extending from the upper valve seat opening 23 along axis A in the direction of the head body 9.

The geometries of the tunnel 41 and the upper valve disk 20 are adapted to each other so that the valve disk 20 is blocking the bypass flow over a certain length of travel of the switch valve 18, including the therewith travelling valve disk 20, from the filtering position to the bypass position. In this embodiment, the valve disk 20 is blocking the by-pass flow route more than half of the length of travel from the filtering position to the bypass position.

In embodiments, the aforementioned blocking of the bypass flow in the tunnel 41 encompasses situations in which bypass leak flows are still able to pass the valve disk 20 in the tunnel 41 so that the blocking is not necessarily a full sealing of the tunnel 41 by valve disk 20, but such leak flows are still noticeably reduced in comparison with the bypass flow when the valve disk 20 in the bypass position.

As can be taken from FIGS. 4 to 6, the moveable switch valve 18 has on its upper, head body-facing side a rod-shaped plunger 28 extending along axis A from the outlet-side of the switch valve housing 19, i.e., from the wet side, through a guiding sliding bearing 29 formed by an inner wall 30 of the head body 9 to a dry side of the head body 9. In particular, the plunger 28 extends through a switching force setting unit 31 which comprises the switching force adjustment mechanism 14 and is connected at its head-side end with the adjustment wheel 13.

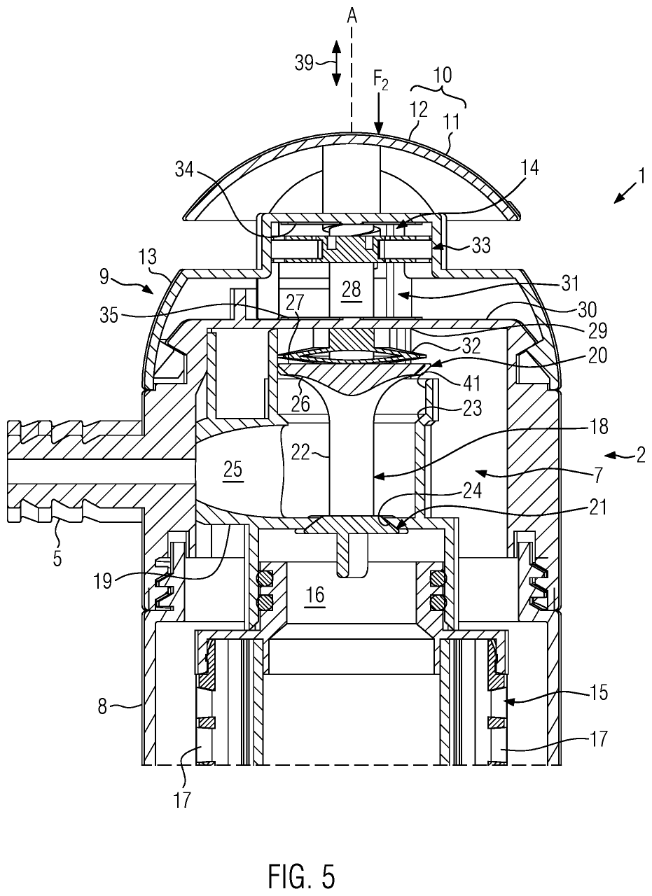

The bearing 29 is sealed off from the liquid flow-side and from any possible particles therein by a shape-changeable sealing 32 which changes its shape along with the switch valve 18 movement, which can be easily seen when comparing the differing shapes of the sealing 32, in particular the sealing shape dimensions along axis A and in the orthogonal direction, between FIGS. 4 and 5. In this embodiment, the sealing 32 is a bellows-like membrane sealing sleeve. Further, in this embodiment, one end of the sealing sleeve 32 is liquid-tight and fixedly attached to the moveable plunger 28 and the other end of the sealing sleeve 32 is liquid-tight and fixedly attached to the stationary inner wall 30 which here forms the bearing 29.

The switching force setting unit 31 is housed in an upper, dry section of the head body 9. In this embodiment, the switching force setting unit 31 comprises a moveable magnetic member 33 and two stationary magnetic members 34, 35. The moveable magnetic member 33 is attached to the plunger 28 such that the plunger 28 and the moveable magnetic member 33 undergo the same axial movements. The switching force setting unit 31 is movably associated with the switch valve 18 via the plunger 28 for defining and/or for adjusting the threshold switching forces to be overcome for moving the switch valve 18 from the filtering position, in which the upper valve disk 20 is closing the upper valve seat opening 23, in the direction of the bypass position and, in this embodiment, also for moving the switch valve 18 from the bypass position, in which the lower valve disk 21 is closing the lower valve seat opening 24, in the direction of the filtering position.

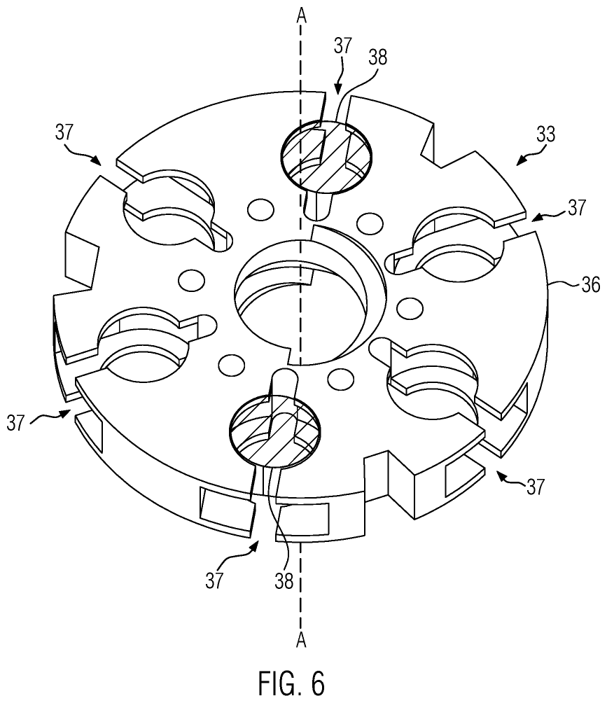

In this embodiment, as can best be seen in FIG. 6, the moveable magnetic member 33 comprises a magnetic carrier 36 containing several receiving portions 37, here in the form of radially open pockets, for attaching and for detaching magnetic subunits 38 (illustrated with hatch lines), here in the form of cylindrical permanent magnets. By selecting an appropriate number of magnetic subunits 38 for the carrier 36, the switching forces can be conveniently defined and changed, if desired, for example during the assembly of the filtering device assembly 2, for a respective application case of the filtering device assembly 2. In an embodiment, it would also be possible to disassemble the filtering device assembly 2 and change the number of subunits 38 to re-define and thus to adjust the switching forces, if desired.

The stationary magnetic members 34, 35 are, in this embodiment, formed by two ferromagnetic plates located in the proximity of the respective ends of the axial magnetic carrier 36 movement path, such that the magnetic carrier 36 experiences a peak magnetic attraction with a ferromagnetic plate 34, 35 in each of its carrier stop positions, in which the switch valve 18 is in the filtering position or in the bypass position.

In this embodiment, the arrangement of the moveable magnetic member 33 and the stationary magnetic members 34, 35 is such that the non-electrically moveable bypass-switch unit 7 is a bistable switch unit with the only stable states being the switch valve filtering position and the switch valve bypass position.

In case the threshold switching force between the magnetic member 33 and the ferromagnetic plate 35 is overcome by the internal liquid pressure differential force F1 (directed along axis A) against the lower side 26 of the bypass valve disk 20 in the filtering position, the valve disk 20 is continuously pushed upwards through the tunnel 41 in the direction of the bypass position.

At the same time, the magnetic attraction force between magnetic member 33 and the plate 34 is increasing and from a certain point prevails over the attraction force with the lower plate 35, which automatically drives the valve disk 20 and thus the entire switch valve 18 on to the bypass position. This constitutes a positive feedback loop and enables for example a beneficial bistable behavior of the bypass switch unit 7. Further, the tunnel 41 allows for the damping of undesired valve oscillations or undesired premature switching to the bypass position due to temporary liquid pressure peaks.

The magnetic attraction with the upper magnetic plate 34 ensures that the magnetic carrier 36 is held in the bypass position until manual operation of the multipurpose head part 10 by a user.

This aforementioned arrangement advantageously ensures that the switch valve 18 only has the two stable position states, filtering and bypass position, and no in-between states/positions.

In the illustrated embodiment, the switching force setting unit 31 further comprises the switching force adjustment mechanism 14 with which the switching forces of the bypass-switch unit 7 can be further adjusted by adjusting the distances between the moveable magnetic member 33 and, in this embodiment, both stationary magnetic members (or here plates) 34, 35. For this purpose, the adjustment mechanism 14 comprises a thread-system. Here, the rotatable and axially moveable magnetic carrier 36 is threadably engaged with the non-rotating plunger 28 and rotatably engaged with the adjustment wheel 13, such that a turning of the adjustment wheel 13 around axis A results in a turning of the magnetic carrier 36 and thus, due to the threaded engagement with the non-rotating plunger 28, in a relative axial movement between the magnetic carrier 36 and the plunger 28. Dependent on the direction of rotation of the adjustment wheel 13, clockwise or counter-clockwise, the position of the magnetic carrier 36 can be moved closer to or away from a stationary magnetic member 34, 35.

The multipurpose head part 10 here also embodies the visual indicator 12 for indicating a bypass position of the switch valve 18 and thus a bypass mode of the filtering device assembly 2 as well as for indicating a filtering position of the switch valve 18 and thus a filtering mode of the filtering device assembly 2.

As follows from the above description, the adjustment of the switching forces by turning the adjustment wheel 13 is even possible when the filtering device assembly 2 is filled with liquid and, here, even when liquid is flowing through the filtering device 1.

In the following, a possible use of the aforementioned filtering device 1 will be briefly described.

During assembly of the filtering device 1, the magnetic carrier 36 is provided in its pockets 37 with a selected amount of magnetic subunits 38 to define the desired switching forces for the intended filtering device 1 use. If required, magnetic subunits 38 already received in respective carrier pockets 37 can also be detached from the carrier 36.

During initial installation of the filtering device 1 on site, the position of the filtering device 1, with respect to, e.g., a washing machine, is basically only restricted by space aspects, as for example the location of the washing machine drain pipe and the pipe leading to the sewer system and an appropriate mounting place-not by the availability of electric power or the electric power cables. The provision or replacing of any batteries is also not required.

The inlet 5 of the filtering device 1 gets fluidly connected by the user to the drain pipe of a washing machine and the outlet 6 to a drain pipe leading to the sewer system. The mounting bracket 4 is attached to a wall of the washing machine or to its vicinity. In the original delivery state, the filtering device assembly 2 is, e.g., in the filtering mode with the switch valve 18 being held by magnetic attraction between the carrier 36 and the lower plate 35 in the filtering position in which the upper valve disk 20 closes the bypass valve opening 23 and the switch unit 7 directs the liquid flow through the filter screen unit 15.

When the user for example wants to wash extremely dirty clothing in the washing machine, he manually pulls the multipurpose head part 10 by applying an external pulling force F3 along axis A to the multipurpose head part 10, axially into the extended position and thus manually changes the filtering device 1 into the bypass mode. Now, the lower valve disk 21 closes the filter valve seat opening 24, such that no liquid flow entering the filtering device 1 under pressure through the inlet 5 can enter the filter screen unit 15, but instead is guided by the bypass-switch unit 7 through the now-open bypass valve seat opening 23 and exits the filtering device 1 unfiltered through the outlet 6.

The sealing sleeve 32 moves along with the movement of the switch valve 18 and becomes axially compressed when the switch valve 18 is moved into the bypass position. The sealing sleeve 32 at no time allows liquid and particles to enter the bearing 29 and thus to negatively affect the switching forces by increasing friction and hindering the movement of the plunger 28.

The switch valve 18 remains in the bypass position through magnetic attraction forces between the magnetic carrier 36 and the upper ferromagnetic plate 34 until a user manually changes this state by pushing the extended multipurpose head part 10, and thereby applying external pushing force F2 (directed along axis A in opposite direction of aforementioned forces F1 and F3) to the multipurpose head part, into its retracted position, which brings the switch valve 18 into the filtering position. When the washing process of the dirty clothing has been finished, the user manually changes the switch valve 18 back into the filtering position. Such actions enable a longer operating period of the filtering device 1 and thus reduce the risk of clogging-induced malfunctions or failures.

Further, when the filtering device 1 has been used for a longer period of time in the filtering mode and the filter screen unit 15 is clogged to such an extent that the differential liquid pressure forces F1 acting on the lower side 26 of the bypass valve disk 20 exceed a bypass switching force previously defined by the amount of subunits 38 in the carrier 36 and its adjusted position to the lower plate 35, the moveable switch valve 18 automatically moves in an axial direction to the bypass position in which it is held by the magnetic forces between the carrier 36 and the upper plate 34. The multipurpose head part 10 is now in the extended position and visually signals to the user that the switch valve 18 is in the bypass position and that the filter screen unit 15 is clogged and requires maintenance. This effect can be emphasized by visible ornamentation attracting the user's attention, which can only be seen when the head part 10 is in the extended position. The multipurpose head part 10 is held in the extended position by magnetic forces until the user manually pushes the multipurpose head part 10 by external force F2 back into its filtering position after maintenance of the filter screen unit 15.

If the user notices that the switch unit 7 prematurely switched into the bypass state or switched too late, for example upon inspection of the filter screen unit 15 clogging state during filter maintenance, he can adjust the switching forces by turning the adjustment wheel 13 by hand clockwise or counter-clockwise to finely adjust the threshold force required to switch the switch valve 18 from the filtering position into the bypass position by changing the distance between the carrier 36 and the lower plate 35 when the switch valve 18 is in the filtering position. Such an adjustment is conveniently possible when the filtering device assembly 2 is still filled with liquid so that no disconnecting from the pipes or disassembly of the filtering device 1 becomes necessary. Further, an adjustment of switching forces is even possible when liquid flows through the filtering device assembly 2.

The event of switching from the filtering mode into the bypass mode, when the inlet 5 pressure exceeds a defined amount of pressure and moves the moveable switch valve 18, takes place automatically without the involvement of electric power and thus reliably avoids pressure-induced malfunctions, such as overpressure-induced washing machine emergency shutdowns or overpressure-induced malfunction of filtering device 1 parts or fittings.

As further follows from the above explanations, by providing a filtering device assembly 2 with a passive bypass-switch unit 7 having a switch valve 18 moveable between the filtering position and the bypass position, wherein the bypass-switch unit 7 is manually switchable between the filtering position and the bypass position and is switchable by pressure from the liquid flow, the bypass-switch unit 7 enables a filtering device 1 having a multitude of clogging-damage-reducing features such that the switch valve 18 can be moved and switched by various non-electric means, e.g., manually or liquid pressure-induced, and its movement can be used for a visual indication of an operational state, all without the use of external energy sources, such as electric power.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A filtering device assembly, comprising:
an inlet,
an outlet, and
a bypass-switch unit fluidly connectable to a filter screen unit for filtering particles, from a flow of liquid flowing from the inlet to the outlet;
the bypass-switch unit comprising a switch valve moveable between a filtering position and a bypass position, wherein in the filtering position the bypass-switch unit, when fluidly connected to a filter screen unit, directs the flow of liquid through the filter screen unit and in the bypass position the bypass-switch unit, when fluidly connected to the filter screen unit, bypasses the flow of liquid past the filter screen unit; and
wherein the bypass-switch unit is a passive bypass-switch unit manually switchable between the filtering position and the bypass position and switchable by pressure from the flow of liquid.

2. The filtering device assembly according to claim 1, wherein the bypass-switch unit comprises a hand-switch movably associated with the switch valve.

3. The filtering device assembly according to claim 1, wherein a part of the switch valve is exposed to a differential liquid pressure between an inlet-side and an outlet-side of the filter screen unit and is moveable by the differential liquid pressure from the filtering position in the direction of the bypass position.

4. The filtering device assembly according to claim 1, further comprising:
a visual indicator configured to indicate an operational state of the switch valve wherein the visual indicator is configured to visually indicate when the switch valve is in the bypass position or the filtering position.

5. The filtering device assembly according to claim 1, wherein the switch valve requires manual operation to be moved from the bypass position into the filtering position.

6. The filtering device assembly according to claim 1, wherein the bypass-switch unit is a bistable switch unit with a first stable state includes the switch valve in the filtering position and a second stable state includes the switch valve in the bypass position, wherein the switch valve is held in the first stable state or in the second stable state by magnetic forces.

7. The filtering device assembly according to claim 1, further comprising a switching force setting unit movably associated with the switch valve for defining or adjusting threshold switching forces to be overcome for moving the switch valve from the filtering position in the direction of the bypass position or from the bypass position in the direction of the filtering position.

8. The filtering device assembly according to claim 7, wherein the switching force setting unit comprises interacting magnetic members moveable relative to each other for defining the threshold switching forces by magnetic forces, wherein a moveable magnetic member is movably associated with the switch valve and configured to move along a path between a bypass stop position and a filtering stop position, and wherein each stop position is in magnetic proximity to one or more stationary magnetic members.

9. The filtering device assembly according to claim 8, wherein the moveable magnetic member is configured to allow for a change of its magnetic strength, wherein the moveable magnetic member comprises a magnetic carrier containing several receiving portions for attaching or detaching magnetic subunits.

10. The filtering device assembly according to claim 8, wherein the switching force setting unit comprises a switching force adjustment mechanism configured to adjust a distance between the moveable magnetic member and at least one of the stationary magnetic members, wherein the switching force adjustment mechanism comprises a thread-system, for adjusting the position of the moveable magnetic member

11. The filtering device assembly according to claim 10, wherein the switching force adjustment mechanism is manually operable by manually turning an adjustment wheel of the adjustment mechanism or the switching force adjustment mechanism is manually operable when the filtering device assembly is filled with liquid.

12. The filtering device assembly according to one claim 1, wherein the bypass-switch unit comprises a switch valve housing containing the switch valve wherein the switch valve housing and the switch valve are adapted to each other such that the switch valve is blocking the bypass flow over a certain length of travel of the switch valve from the filtering position to the bypass position over at least one of at least a third of the length of travel from the filtering position to the bypass position or at least half of the length of travel from the filtering position to the bypass position.

13. The filtering device assembly according to claim 1, wherein the moveable switch valve is guided by a bearing, wherein the bearing is sealed off from the liquid flow by a shape-changeable sealing changing its shape along with the switch valve movement by a flexible sealing sleeve.

14. A filtering device, comprising
the filtering device assembly according to claim 1, and
a filter screen unit fluidly connected to the bypass-switch unit for filtering particles from the flow of liquid flowing from the inlet to the outlet.

15. A method of operating a filtering device assembly for filtering particles, from liquid flowing through the filtering device assembly, the method comprising:
manually switching a moveable switch valve of a passive bypass-switch unit between a filtering position and a bypass position, wherein in the filtering position the bypass-switch unit directs the flow of liquid through a filter screen unit and in the bypass position the bypass-switch unit bypasses the flow of liquid past the filter screen unit, and
switching the switch valve by pressure from the flow of liquid.

16. The method according to claim 15, comprising exposing the switch valve to differential liquid pressure between an inlet-side and an outlet-side of the filter screen unit, and
moving the switch valve by the differential liquid pressure from the filtering position in the direction of the bypass position.
